(19) United States
(12) Patent Application Publication
(10) Pub. No.: US 2008/0145306 A1
(43) Pub. Date: Jun. 19, 2008

(54) Method For Producing Spherical Mixed Oxide Powders In A Hot Wall Reactor

(76) Inventors: Guenter Riedel, Kelkheim (DE); Matthias Koch, Wiesbaden (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/816,220

(22) PCT Filed: Jan. 14, 2006
(86) PCT No.: PCT/EP2006/000298

§ 371 Date: Aug. 14, 2007

(30) Foreign Application Priority Data
Feb. 15, 2005 (DE) 102005007036.1

(51) Int. Cl. B24D 3/02; C09K 11/02

(52) U.S. Cl. 423/600; 423/593.1; 51/309; 252/301.4 R; 252/301.6 R; 252/301.4 F; 252/301.6 F; 252/301.5

(57) ABSTRACT

The present invention relates to a novel process for the production of spherical binary and multinary mixed oxide powders in a hot-wall reactor. Through the use of aqueous or organic salt solutions or suspensions having a limited salt or solid concentration in combination with additives in the form of surfactants and/or of inorganic salts which have an exothermic decomposition reaction, a compact spherical particle morphology can be obtained, where the average particle size is in the range from 5 nm to <10 μm.

The present invention relates to a novel process for the production of spherical binary and multinary mixed oxide powders by spray pyrolysis in a hot-wall reactor.

### Prior art

Aerosol processes and especially spray pyrolysis are regarded as effective processes for the production of high-quality and homogeneous multicomponent powders.

In particular in the case of multinary mixed oxide systems, the processes of solvent evaporation, thermal decomposition of the salts separated from these solutions and the formation of the mixed oxides are advantageously achieved in a single process step starting from solutions, suspensions or dispersions.

The scientific and technical basic principles are described by G. L. Messing et. al. in Journal of the American Ceramic Soc. 76 (1993) 11, pp. 2707-2726, where it is stated, inter alia, that the formation of hollow particles or shell fragments is one of the main reasons why this process has not been widely used to date in the production of powders. On use of inexpensive nitrates, which usually have a low melting point, the inclusion of solvent residues in the newly formed salt particles additionally finally results in the formation of porous oxide particles of irregular shape.

This disadvantage usually cannot be overcome in processes based on flame pyrolysis or can only be overcome by the spraying of emulsions. For example, aqueous mixed nitrate solutions with the elements Zn, Sb, Bi, Co, Mn, Cr are firstly dispersed and emulsified in an organic phase before the spray pyrolysis (DE 4307 333).

In WO 90/14307 and DE 3916643, the process of flame spray pyrolysis is specially designed by spraying metal nitrate solutions in the presence of organic substances functioning as fuel, such as, for example, ethanol, isopropanol, tartaric acid or elemental carbon, and in this way substantially selfsupporting combustion proceeds after ignition. This process is used in the preparation of zinc oxide with additives of Bi, Mn, Cr, Co, Sb₂O₃ and Bi₂Ti₂O₇ powder.

Patent application DE 10 2005 002659.1 by Merck (date of filing: 19.01.2005) describes how mixed oxide powders consisting of compact, spherical particles can be produced by a special process design in a pulsation reactor. In order to carry out this process, the starting solutions are sprayed into a stream of hot gas generated by pulsating, flameless combustion.

As already stated, the inclusion of solvents in the interior of particles and the warming of the particles taking place from the outside inwards by convection or radiation, as occurs during flame pyrolysis or also in the case of an externally electrically heated hot-wall reactor, is the undesired cause of the form ation of porous, hollow particles of irregular shape.

The object of the present invention is therefore to provide a process which can be carried out in a simple manner, does not have these disadvantages and allows the production of compact spherical metal oxide particles or corresponding powders. In particular, an object of the present invention is to provide a corresponding process by means of which binary or multinary mixed oxides can be prepared in a simple and inexpensive manner.

The present object is achieved in accordance with the invention by spray pyrolysis of usually aqueous salt solutions or suspensions having a limited salt or solid concentration in a hot-wall reactor, where inorganic salts which decompose exothermically under the process conditions and thus promote the formation of non-porous, compact spherical particles are optionally added to the solutions or suspensions. In particular, the present object is also achieved by addition of a surfactant, further improving the particle morphology.

The present invention therefore relates, in particular, to a process for the production of spherical, binary or multinary mixed oxide powders having average particle sizes <10 μm by spray pyrolysis, which is characterised in that

a) at least two starting materials in the form of salts, hydroxides or mixtures thereof are dissolved or dispersed in water, bases or acids, or one or more starting materials are dispersed in the salt solution, and
b) a surfactant and/or an inorganic salt which decomposes in an exothermic reaction is added, and
c) this mixture is sprayed in an electrically heated pyrolysis reactor, thermally decomposed and converted into mixed oxides.

In order to carry out this process, the starting materials used are organometallic compounds, in particular salts, hydroxides or organometallic compounds of the elements from groups IIA (IUPAC: 2), IIIA (13), IIIB (3) and VIB (6), which are dissolved or dispersed in organic solvents. The starting materials used can preferably be nitrates, chlorides, hydroxides, acetates, ethoxides, butoxides or isopropoxides, or mixtures thereof. Suitable starting materials are, in particular, also aluminates of the elements from groups IIA and IIIB.

Particularly good product properties are achieved if, in order to carry out the process according to the invention, an inorganic salt which decomposes in an exothermic reaction, selected from the group nitrate, chlorate, perchlorate and ammonium nitrate, individually or in a mixture, is employed and in an amount of 10 to 80%, preferably 25-50%, based on the amount of starting material employed, and a surfactant selected from the group fatty alcohol ethoxylate, sorbitan oleate and amphiphilic polymer in an amount of 3-15%, preferably 6-10%, based on the total weight of the solution, are added.

The present invention thus relates to mixed oxide powders which have been produced by the process described and have an average particle size in the range from 0.005 to <10 μm, a specific surface area (by the BET method) in the range 3-30 m²/g, preferably 5-15 m²/g, and a compact, spherical morphology. However, the present invention also relates to mixed oxide powders having average particle sizes in the range 0.005-2 μm, or, for special requirements, having particle sizes in the range 1-5 μm. The object according to the invention is achieved, in particular, by mixed oxide powders produced by the process according to the invention, having average particle sizes in the range 0.1-1 μm, a specific surface area (by the BET method) in the range 10-60 m²/g, preferably 20-40 m²/g, and a compact, spherical morphology. Mixed oxide powders produced in accordance with the invention whose average particle size are in the range from 0.005 to 0.1 μm and which have a specific surface area (by the BET method) in the range 40-350 m²/g, preferably 50-100 m²/g, have particularly advantageous properties.

Mixed oxide powders produced in accordance with the invention are particularly suitable for the production of high-density, high-strength and optionally transparent ceramic or for the production of high-density, high-strength and optionally transparent bulk material by means of hot-pressing technology. These mixed oxides are particularly suitable as base material for phosphors or as phosphor. However, they can also be used as filler in polymers or rubber as polishing agent.

In order to carry out the process according to the invention, the solutions, dispersions or suspensions prepared in advance are sprayed into an externally electrically heated tube by means of a two-component nozzle with a defined air/feed ratio. The principle is illustrated in the depiction of FIG. 1. The powder is separated from the stream of hot gas with the aid of a porous metal filter.

The requisite reduced energy input immediately after the spray-in point takes place automatically in this reactor through the cooling effect as a consequence of solvent evaporation and the low turbulence of the flow.

Additional energy is introduced in accordance with the invention by a chemical decomposition reaction of inorganic salts, for example of nitrates, chlorates, or perchlorates, which are introduced, for example, in the form of alkali metal nitrates or preferably in the form of ammonium nitrate, where the latter additionally has an oxidising action. The addition of an additional surfactant, for example in the form of a fatty alcohol ethoxylate, effects the formation of finer and more spherical particles.

Using the example of powders based on Mg and Y aluminates, it can be shown that the combination according to the invention of the various additives with the use of the hot-wall reactor described enables the production of finely dispersed, compact, spherical powders having average particle sizes in the range 0.005-2 μm.

The starting materials used here are mixed nitrate solutions which comprise the corresponding elements in the desired stoichiometric ratio. Ammonium nitrate in an amount of 10-50%, preferably 20-40%, based on the salt content of the starting solution, is preferably added to these solutions as chemical energy carrier. The particle size can be reduced further by dilution by 25-50%.

Surprisingly, it has been established, established by experiments that an Mg/Al mixed nitrate solution is converted completely into MgAl₂O₄ under the conditions according to the invention in a hot-wall reactor having a length of 1.5 m at a reactor temperature of only about 1050° C. The morphology of the particles produced in this way is spherical, and the average particle size is 1.8 μm (see FIG. 2).

It has proven particularly surprising here that spinel formation by means of spray pyrolysis takes place in the short-time reactor described here not only by dissolution, but also by dispersion of suitable salts or hydroxides, such as, for example, Mg(OH)₂, in Al nitrate solution without residual single oxides being detectable roentgenographically. An average particle size of 3.5, μm is achieved by addition of ammonium nitrate (see Example 2).

Whereas the dispersion of an oxide, such as, for example, nanodisperse Al₂O₃, in an Mg salt solution using the reactor described here does not result in mixed oxide formation, the spinel phase can be detected roentgenographically alongside an amorphous powder fraction by spraying and pyrolysis of Al hydroxide, for example in the form of AlO(OH), dispersed in an Mg acetate solution. Complete conversion into the spinel can also be carried out by calcination at 1200° C. in the presence of air (see Example 3). A submicron or nanopowder can be produced in this way.

Similar particle-size distribution and particle morphology results as in the case of magnesium aluminium oxide are also obtained on use of yttrium/aluminium mixed nitrate solutions. The combined addition of water, ammonium nitrate and surfactant and the establishment of suitable temperature conditions in the reactor enable the particle morphology, the size and size distribution thereof to be influenced specifically. Thus, powders produced in accordance with the invention have round solid particles in a size of up to about 8 μm (see FIG. 3).

In this case, it is not the crystalline phase Y₃Al₅O₁₂ corresponding to the chemical starting composition, but instead about 90% of X-ray-amorphous constituents and 2-5% of cubic Y₃Al₅O₁₂, about 3-6% of YAlO₃ and about 2% of Y₂O₃ that are initially formed. The material can be converted completely into the cubic YAG phase by subsequent thermal treatment in the temperature range from 900° C. to 1200° C., preferably 1100° C.

Use of a Y chloride solution mixed with an Al nitrate solution in the stoichiometric ratio corresponding to the desired later stoichiometry of the product to be produced enables powders having similar features to be produced. Approximately 80% of amorphous powder fractions are formed here with very short product residence time in the hot-wall reactor already mentioned having a length of about 1.5 m. The crystalline phases, besides the Y₃Al₅O₁₂ target phase, are the YAlO₃ phase in approximately equal proportion and highly reactive transition aluminium oxides (kappa and theta phase) and yttrium oxide. This phase mixture can likewise be converted into the YAG phase by calcination at about 1000° C.

The powders produced using the agents described above, which have very different particle sizes and particle size distributions, can be further processed and used in various ways, such as, for example, for the production of high-density ceramic materials, layers, as fillers and polishing materials.

Magnesium or yttrium aluminates doped with rare earth (RE) elements, such as, for example, Ce, Pr, Nd, Sm, Eu, Gd, Tb, Dy, Er, Tm, Yb and mixtures thereof can be employed as phosphor materials, where the above-mentioned RE metals act as activator elements [Angew. Chem. 110 (1998); pp. 3250-3272].

The process according to the invention enables pulverulent substance systems with partial substitution of elements, even in low percentages, to be produced advantageously. By mixing and spraying salt solutions, homogeneous distributions of the elements in the particles can be achieved. Even if a subsequent calcination process is necessary in order to establish a certain phase composition, the temperatures necessary for this purpose are lower than in the so-called “solid state processes”, which are not based on the pyrolysis principle, and the powder morphology and the homogeneity are retained as far as the end product.

As shown in Examples 5 and 6, Ce-doped Y₃Al₅O₁₂ powder can be produced.

These powders can advantageously be used as phosphor base material since their spherical morphology means that higher packing densities can be achieved compared with other geometrical shapes. In this form, they can be employed particularly advantageously for the production of white-light-emitting illumination systems by combination of a blue emitter with the above-mentioned phosphors, for example for inorganic and organic light-emitting diodes.

For better understanding and in order to illustrate the invention, examples which are within the scope of protection of the present invention are given below. However, owing to the general validity of the inventive principle described, these are not suitable for reducing the scope of protection of the present application to these examples alone.

### EXAMPLES

### Example 1

Magnesium nitrate hexahydrate (analytical grade from Merck KGaA) and aluminium nitrate nonahydrate (analytical grade from Merck KGaA) are each dissolved separately in ultrapure water. The metal contents of the solutions are determined by means of complexometric titration. They are 6.365% of Mg and 4.70% of Al. An Mg/Al mixed nitrate solution which comprises the elements Mg and Al in the molar ratio 1:2 is prepared by vigorous stirring. The solution is diluted with ultrapure water in the ratio 1:1.

Ammonium nitrate (analytical grade from Merck KGaA) in an amount of 30%, based on the nitrate salt content, and a fatty alcohol ethoxylate (Lutensol AO3 from BASF AG) in an amount of 7.5%, based on the weight of the entire solution, are furthermore added.

This mixture is sprayed into a hot-wall reactor having a length of 1.5 m by means of a two-component nozzle. The particles are separated from the stream of hot gas by means of sintered metal hot-gas filters.

Further reactor parameters:

feed throughput: 1.2 kg/h
air pressure at the two-component nozzle: 4.0 bar
reactor temperature: 1050° C.
filter temperature: 350° C.

### Powder Properties:

calcination loss: 2.1%
particle size distribution: d₅₀=1.8 μm, d₉₅=3.5 μm, d_{99.9}=7 μm
particle morphology: spherical particles (see FIG. 2)
specific surface area (BET): 16 m²/g
phases (X-ray diffractometry): spinel (MgAl₂O₄)

### Example 2

0.03 kg of Mg(OH)₂ of the Magnifin H10 type from Magnesia-Produkte GmbH are dispersed in 0.6 kg of Al nitrate solution having a metal content of 4.5%, and, after addition of 0.125 kg of ammonium nitrate, the mixture is sprayed into the hot-wall reactor as described in Example 1 and pyrolysed.

### Powder Properties:

calcination loss: 2.3%
particle size distribution: d₅₀=3.5 μm, d₉₅=9.0 μm, d_{99.9}=17 μm
particle morphology: spherical particles
specific surface area (BET): 21 m²/g
phases (X-ray diffractometry): spinel (MgAl₂O₄) without detection of residual single oxides.

### Example 3

AlO(OH) as Al component is dispersed in a magnesium acetate solution (aqueous) with the following weights of starting materials:
0.8 kg of AlO(OH) of the Martoxal BN-2A type from Albemarle Corp.
1.43 kg of Mg acetate.4H₂O dissolved in 2 kg of water

The suspension is sprayed into the hot-wall reactor with the parameters given in Example 1 by means of a two-component nozzle and pyrolysed.

### Powder Properties:

calcination loss: 3.1%
specific surface area (BET): 40 m²/g
average particle size (calculated from BET): 0.04 μm
particle morphology: spherical particles
phases (X-ray diffractometry): crystalline fractions of spinel (MgAl₂O₄) and oxides of Mg and Al.

Complete conversion into the spinel is carried out by calcination at 1200° C. in air in a chamber furnace for 4 h.

### Example 4

Yttrium nitrate hexahydrate (Merck KGaA) and aluminium nitrate nonahydrate (analytical grade from Merck KGaA) are each dissolved separately in ultrapure water so that the solutions have a metal content, according to complexometric titration, of 15.4% of Y and 4.7% of Al. A Y/Al mixed nitrate solution which comprises the elements Y and Al in the molar ratio 3:5 is then prepared by vigorous stirring. The solution is diluted with ultrapure water in the ratio 1:1. Ammonium nitrate (analytical grade from Merck KGaA) in an amount of 30%, based on the nitrate salt content, and a fatty alcohol ethoxylate (Lutensol AO3 from BASF) in an amount of 7.5%, based on the weight of the entire solution, are furthermore added.

After stirring for 2 hours, this mixture is sprayed into a hot-wall reactor having a length of 1.5 m by means of a two-component nozzle. The particles are separated from the stream of hot gas by means of sintered metal hot-gas filters.

Reactor parameters:

feed throughput: 1.3 kg/h
air pressure at the two-component nozzle: 4.0 bar
reactor temperature: 1050° C.
filter temperature: 325° C.

### Powder Properties:

calcination loss: 0.5%
particle size distribution: d₅₀=2.1 μm, d₉₅=4 μm, d_{99.9}=7.5 μm
particle morphology: spherical particles (see FIG. 3)
specific surface area (BET): 6.9 m²/g
phases (X-ray diffractometry): 91% of X-ray-amorphous constituents; 2% of Y₃Al₅O₁₂, about 4.5% of YAlO₃, 2% of Y₂O₃.

After calcination at 1100° C. in air for 4 h:
specific surface area (BET): 4.8 m²/g
crystalline phases (X-ray diffractometry): 98% of cubic YAG phase; 1.5% of hexagonal YAl₁₂O₁₉, 0.5% of monoclinic Y₄Al₂O₉.

### Example 5

Yttrium nitrate hexahydrate (Merck KGaA), aluminium nitrate nonahydrate (analytical grade from Merck KGaA) and cerium nitrate hexahydrate (“extrapure” grade from Merck KGaA) are each dissolved separately in ultrapure water so that the solutions have a metal content of 15.4% by weight of Y, 4.7% by weight of Al and 25.2% by weight of Ce. A Y/Al/Ce mixed nitrate solution which comprises the elements Y, Al and Ce in the molar ratio 2.91:5:0.09 is prepared by vigorous stirring for 2 hours. This solution is diluted with ultrapure water in the ratio 1:1, and ammonium nitrate (analytical grade from Merck KGaA) in an amount of 30%, based on the nitrate salt content, is then furthermore added.

This mixture is sprayed into a hot-wall reactor having a length of 1.5 m by means of a two-component nozzle. The particles are separated from the stream of hot gas by means of sintered metal hot-gas filters.

Reactor parameters:

feed throughput: 1.2 kg/h
air pressure at the two-component nozzle: 4.0 bar
reactor temperature: 1050° C.
filter temperature: 330° C.

### Powder Properties:

calcination loss: 0.5%
particle size distribution: d₅₀=1.7 μm, d₉₅=3.9 μm, d_{99.9}=6.5 μm
particle morphology: spherical particles
specific surface area (BET): 6.5 m²/g
phases (X-ray diffractometry): crystalline fractions in the form of Y₃Al₅O₁₂, YAlO₃, Y₂O₃ and amorphous fractions presumably in the form of oxides

After calcination at 1130° C. in air for 4 h:
specific surface area (BET): 4.8 m²/g
crystalline phases (X-ray diffractometry): 95% of cubic mixed crystal phase.
particle morphology: spherical particles (see FIG. 4)

### Example 6

A mixed nitrate solution is prepared and the spray pyrolysis carried out in accordance with Example 5.

The powder is calcined at 1100° C. in air in a chamber furnace for 10 h and then has the following properties:
particle size distribution: d₅₀=2.3 μm, d₉₅=4.5 μm, d_{99.9=}8.5 μm
particle morphology: spherical particles
specific surface area (BET): 3.4 m²/g
phases (X-ray diffractometry): 98% of cubic mixed crystal phase

### FIGURES

FIG. 1: diagram showing the principle of a hot-wall reactor

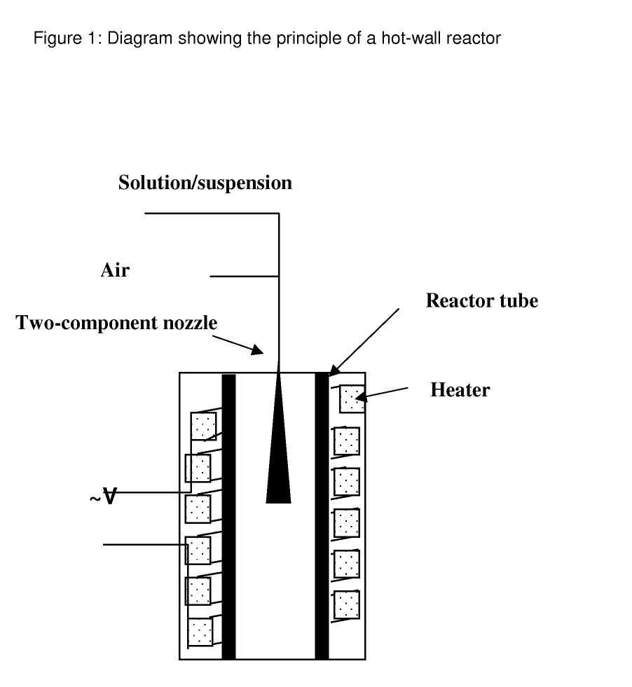

FIG. 2: SEM picture of an Mg/Al oxide powder (in accordance with Example 1)

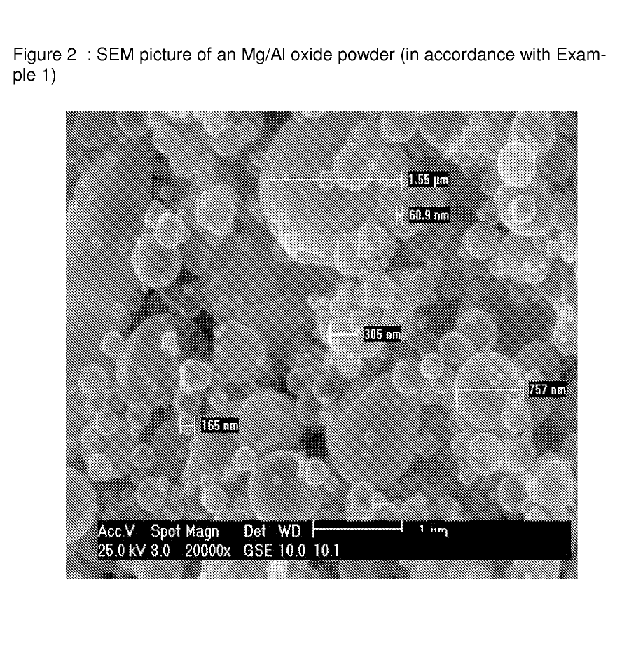

FIG. 3: SEM picture of a Y/Al oxide powder (in accordance with Example 4)

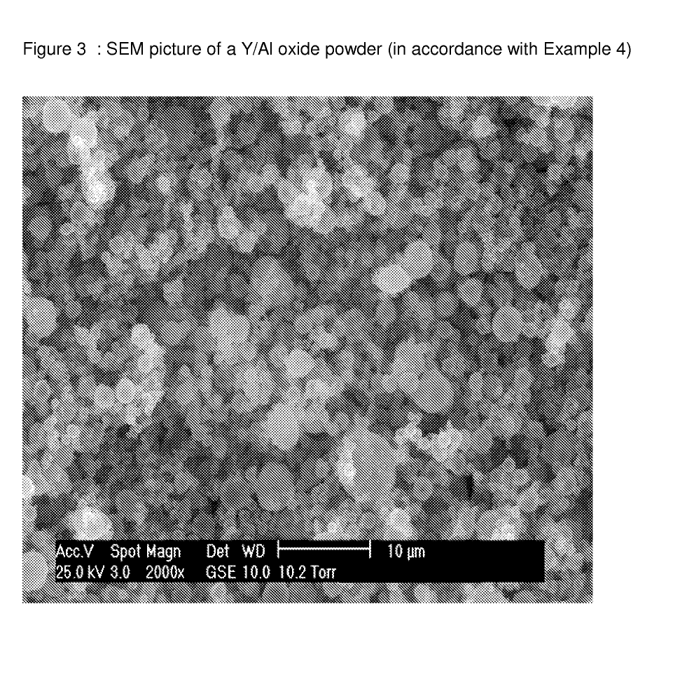

FIG. 4: SEM picture of a Y/Al oxide powder with addition of cerium (in accordance with Example 5)

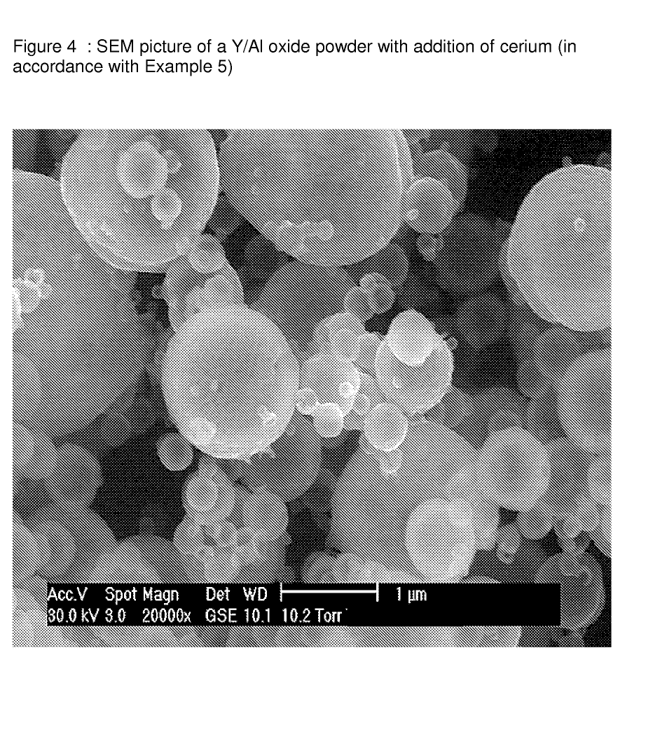

1. Process for the production of spherical, binary or multinary mixed oxide powders having average particle sizes <10 μm by spray pyrolysis, characterised in that
a) at least two starting materials in the form of salts, hydroxides or mixtures thereof are dissolved or dispersed in water, bases or acids, or one or more starting materials are dispersed in the salt solution, and
b) a surfactant and/or an inorganic salt which decomposes in an exothermic reaction is added, and
c) this mixture is sprayed in an electrically heated pyrolysis reactor, thermally decomposed and converted into mixed oxides.

2. Process according to claim 1, characterised in that the starting materials used are organometallic compounds which are dissolved or dispersed in organic solvents.

3. Process according to claim 1, where salts, hydroxides or organometallic compounds of the elements from groups IIA (IUPAC: 2), IIA (13), IIIB (3) and VIB (6) are used.

4. Process according to claim 1, characterised in that the starting materials used are nitrates, chlorides, hydroxides, acetates, ethoxides, butoxides or isopropoxides, or mixtures thereof.

5. Process according to claim 1, characterised in that the starting materials used are aluminates of the elements from groups IIA and IIIB.

6. Process according to claim 1, characterised in that the inorganic salt used, which decomposes in an exothermic reaction, is selected from the group nitrate, chlorate, perchlorate and ammonium nitrate, individually or in a mixture, and is added in an amount of 10 to 80%, 25-50%, based on the amount of starting material employed.

7. Process according to claim 1, characterised in that a surfactant selected from the group fatty alcohol ethoxylate, sorbitan oleate and amphiphilic polymer is used in an amount of 3-15%, preferably 6-10%, based on the total weight of the solution.

8. Mixed oxide powder, produced by a process according to claim 1, characterised in that the average particle size is in the range from 0.005 to <10 μm, has a specific surface area (by the BET method) in the range 3-30 m²/g, preferably 5-15 m²/g, and has a compact, spherical morphology.

9. Mixed oxide powder according to claim 8, characterised in that the average particle size is in the range 0.005-2 μm.

10. Mixed oxide powder according to claim 8, characterised in that the average particle size is in the range 1-5 μm.

11. Mixed oxide powder, produced by a process according to claim 1, characterised in that its average particle size is in the range 0.1-1 μm, has a specific surface area (by the BET method) in the range 10-60 m²/g, preferably 20-40 m/g, and has a spherical morphology.

12. A method for the production of high-density, high-strength and optionally transparent ceramic comprising using the mixed oxide powder of claim 8.

13. Mixed oxide powder, produced by a process according to claim 1, characterised in that its average particle size is in the range from 0.005 to 0.1 μm, has a specific surface area (by the BET method) in the range 40-350 m²/g, preferably 50-100 m²/g and has a spherical morphology.

14. A method for the production of high-density, high-strength and optionally transparent bulk material by means of hot-pressing technology using the mixed oxide powder of claim 8.

15. A method of preparing a phosphor comprising using an oxide powder of claim 8 as a phosphor or as a base material for a phosphor.

16. A method of filling comprising using a mixed oxide powder of claim 8 as filler in polymers or rubber.

17. A method of polishing comprising use of a mixed oxide powder according to claim 8 as polishing agent.
